(19) United States
(12) Patent Application Publication
(10) Pub. No.: US 2025/0311878 A1
(43) Pub. Date: Oct. 9, 2025

(54) REFRIGERATOR LIQUID BREWING AND STORAGE SYSTEM

(71) Applicant: Hisense USA Corporation, Suwanee, GA (US)

(72) Inventors: Heng Tong Pit, Suwanee, GA (US); Steven J. Kuehl, Sylva, NC (US); JinXiong Pi, Suwanee, GA (US)

(73) Assignee: Hisense USA Corporation, Suwanee, GA (US)

(21) Appl. No.: 19/169,122

(22) Filed: Apr. 3, 2025

Related U.S. Application Data
(60) Provisional application No. 63/574,568, filed on Apr. 4, 2024.

(51) Int. Cl. A47J 31/06; A47J 31/52; A47J 31/54; F25D 23/12

(52) U.S. Cl. CPC A47J 31/0631; A47J 31/525; A47J 31/54; F25D 23/126

(57) ABSTRACT

A refrigerator includes a water dispenser, a liquid storage receptacle, a docking base, and a beverage brewer to provide an automatically filling chilled beverage storage solution. The water dispenser is configured to selectively dispense water into the liquid storage receptacle when the receptacle is positioned in the docking base to engage the water dispense. The beverage brewer is positioned in the liquid storage receptacle and comprises a diffuser and a strainer. A filter medium is provided in a volume between the diffuser and the strainer for providing the medium to the water for producing a chilled beverage.

### CROSS-REFERENCE TO RELATED APPLICATION

This application claims the benefit and priority under 35 U.S.C. § 119(e) of U.S. provisional application Ser. No. 63/574,568, filed on Apr. 4, 2024, the content of which is incorporated herein by reference in its entirety.

### TECHNICAL FIELD

The present disclosure relates generally to a refrigerator cold brew coffee system, and more specifically to an automatically filling cold brew coffee system, assemblies, subassemblies, and components thereof.

### BACKGROUND

Refrigerators may incorporate water dispensing systems and water storage systems to dispense and store chilled water. Coffee makers, such as those with automated processing, are commonly operated to make hot coffee. Conventional systems of making cold brew coffee typically require a user to manually brew the coffee and store the brewed coffee in a refrigerator for chilling and/or further steeping.

### BRIEF DESCRIPTION OF THE DRAWINGS

FIG. 1 is a schematic partial front view of a refrigerator fresh food storage section with an open access door, the refrigerator fresh food storage section including a water dispenser and a door mounted pitcher;

FIG. 2 is a schematic cross-sectional side view of an exemplary water dispenser system for a refrigerator;

FIG. 3 is a schematic exploded view of a beverage brewing apparatus;

FIG. 4 is a schematic view of an exemplary liquid storage receptacle having the beverage brewing apparatus of FIG. 3;

FIG. 5 is a schematic view of an exemplary water heater; and

FIG. 6 is a flow chart illustrating a method of brewing coffee.

Like reference numerals indicate like parts throughout the drawings.

### DETAILED DESCRIPTION

A refrigerator is a household appliance with a refrigeration compartment and in some instances may also have a freezer compartment. The refrigerator may attach to a water source to incorporate a water dispenser at the exterior surface of a door enclosing one of the compartments and/or an interior surface of the door or a wall of the refrigeration compartment. Also, a liquid storage receptacle, such as a pitcher, may be provided in an interior portion of the refrigeration compartment. The refrigerator disclosed herein provides a cold brew coffee system in the refrigeration compartment that is integrated with the water source that feeds the water dispenser to fill a pitcher with cold brewed coffee.

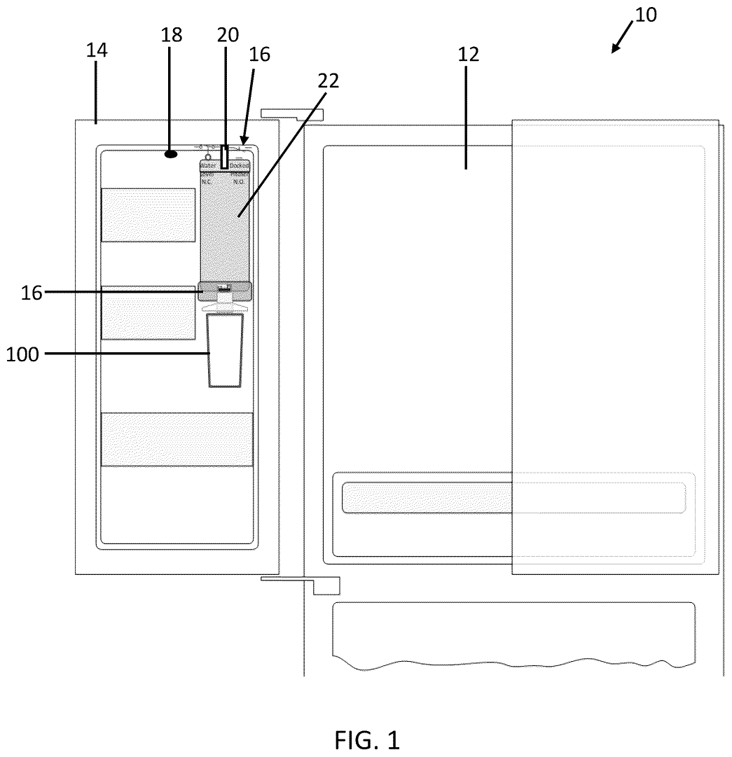

Referring to FIG. 1, an example of a refrigerator 10 is provided, showing a refrigeration compartment, which may be referred to as a fresh food storage section 12 of the refrigerator 10. The fresh food storage section 12 is enclosed by two front access doors in a French-door configuration. As shown in FIG. 1, refrigerator 10 has an access door 14 in an open position. The refrigerator 10 includes an integrated water dispenser 16. The water dispenser 16 may be integrated into the surface of the top wall of the door 14. In other examples, the water dispenser may be integrated into a different surface of the refrigerator, including the surface of a side wall of the refrigerator, the surface of the top wall of the refrigerator, or the surface of a side wall of the access door. The water dispenser 16 may include an actuator 18, such as a button or switch, in close proximity to a dispenser nozzle 20. In one example, a user may open the access door 14 to the fresh food storage section 12 and place a glass or other fluid container held in the user's hand beneath the dispenser nozzle 20 and engage the dispenser 16 by pressing the actuator 18, thereby dispensing chilled water into the fluid container. The dispenser 16 may also be engaged by a liquid storage receptacle that is docked in the refrigerator, such that the dispenser 16 may alternatively be accessed directly by the user with a glass or other fluid container held in a user's hand when the liquid storage receptacle is removed or otherwise disengaged from the dispenser. In other examples, the dispenser 16 may not include a user activated actuator and my solely be used with engaging a liquid storage receptacle 22.

The refrigerator 10 includes an automatically filling liquid storage receptacle, for example a pitcher 22, that can be stored or docked in the refrigerator 10. The pitcher 22 is configured to interface with the water dispenser 16 to automatically flow or dispense water into the pitcher 22 upon an initiation command, which may correspond to the pitcher 22 being empty or having liquid below a low-level threshold, and in additional examples may correspond to a scheduled time or another triggering condition or event. When interfacing with the water dispenser 16, the pitcher 22 is also configured to stop filling or dispensing water upon a stop command, which may correspond to the disengaging of the pitcher 22 or when the liquid in the pitcher 22 meets or exceeds a high-level threshold. The refrigerator 10 includes a docking station 24 configured to engage the pitcher 22 to ensure proper placement and orientation of the pitcher 22 relative to the water dispenser 16. The docking station 26 may be provided directly below the water dispenser 16 as in the exemplary arrangement shown in FIG. 1. In other examples, the docking station 24 may be positioned in an integrally formed support feature or a storage bin on the door 14, or located in the cabinet portion of the fresh food storage section 12. In some examples, the pitcher 22 may be sized to contain about one gallon of liquid. In other alternatives, the pitcher may be larger or smaller, and be sized to contain about one-half galloon, one-and-a-half liters, two liters, one-and-a-half gallons, or other suitable sizes. The pitcher 22 may be sized to be integrated into existing refrigerator designs, maintaining clearance from a door dyke, door gaskets and seals, and storage bins including crisper bins and deli/pantry bins.

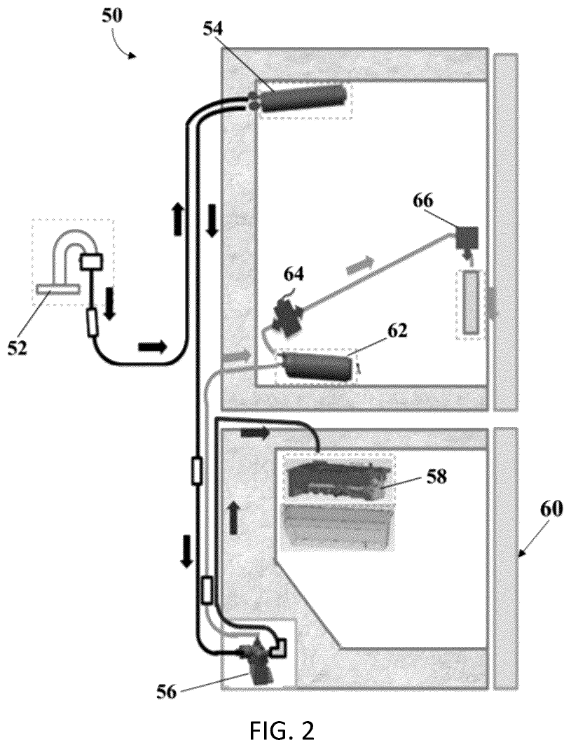

Referring now to FIG. 2, an exemplary water line diagram 50 shows that the refrigerator 10 may be connected to a water source 52, such as a residence's domestic fresh water service. The refrigerator 10 may incorporate a filtering device 54, such as a replaceable, disposable, or cartridge filter device for removing impurities or particulate debris from the water supply, preventing clogging of downstream components, and avoiding unpleasant or undesirable flavors or odors in the water. The filter device 54 may include activated carbon filters, such as from charcoal, nutshells or wood, or other suitable media. After filtering, the water may be directed to a fill valve 56. The fill valve 56 may supply one or more fluid circuits, for example, to supply the water dispenser 16 and to an automatic ice maker 58 provided in a freezer section 60. Between the fill valve 56 and the water dispenser 16, the refrigerator 10 may include a water tank 62 permanently provided in the fresh food storage section 12 in order to increase the ready supply of chilled water for dispensing through the dispenser 16. A water valve 64 may be provided proximate to the water tank 62 to control the fill level of the water tank 62 and assist in communicating the water from the water tank 62 to the water dispenser 16. A control switch 66 may be provided proximate the water dispenser 16 that the user can actuate and control the water flow through the water dispenser 16. The control switch 66 may also be provided to engage or disengage the water dispenser 16 based upon position and fill conditions of a liquid storage receptacle 22 as described in further detail below. This arrangement is illustrative of an exemplary implementation and is not intended to be limited. Alternative arrangements are contemplated to be within the scope of the present disclosure, for example, that omit the filer 54, the automatic ice filter 58, or otherwise.

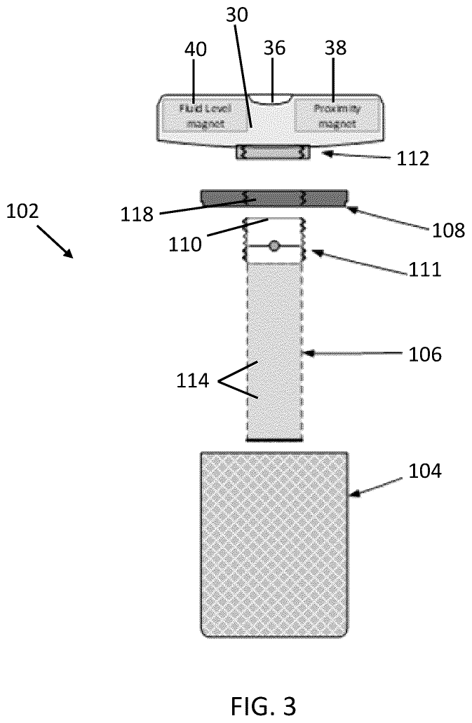

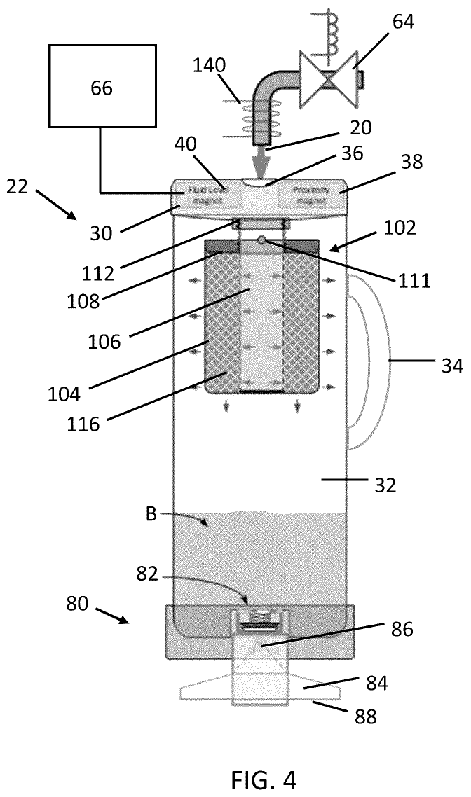

Referring now to FIGS. 3 and 4, an exemplary pitcher 22 and lid 30 are shown. The pitcher 22 includes a pitcher body 32. A handle 34 is secured to the pitcher body 32 to aid in handling the pitcher 22. The handle may be provided in various arrangements, such as to at least partially extend from the pitcher body and to be integrally formed with the pitcher body. A lid 30 encloses the pitcher body 32 and may incorporate a spout to be used for aiding in pouring liquid from the pitcher 22 when the pitcher 22 is removed from the docking station 24 and the refrigerator 10. The lid 30 may also be configured to engage the water dispenser 16. For example, in the illustrated arrangement, the lid 30 includes a fill port 36 in which the dispenser nozzle 20 interfaces to provide water from the water dispenser 16 into the pitcher body 32. The lid 30 may also include a variety of magnets, contacts, or sensors configured to engage the water dispenser 16 and control switch 66. For example, the lid 30 may include a proximity magnet or sensor 38 which is configured to determine when the pitcher 22 is docked and aligned with the dispenser nozzle 20. In other examples, the lid 30 may also include a fluid level sensor 40 or other accessory for sensing the liquid level of the pitcher 22. The magnets, contacts, and/or sensors may be electrically coupled to a controller 66 for determining when the water dispenser 16 should be engaged to automatically fill the pitcher 22 with water.

In some examples, the pitcher 22 is provided with a beverage dispenser 80 configured to dispense liquid from the pitcher 22 while the pitcher 22 remains docked in the refrigerator 10. The pitcher 22 may include a valve 82 integrated into the bottom portion of the pitcher 22. For example, the valve 82 may be a spring loaded check valve. In some examples, such as shown in FIG. 4, the valve 82 is raised slightly above the interior bottom surface of the pitcher 22 such that the flow of sediment such as coffee grounds into a user's container through the valve is reduced or prevented. When docked and not engaged, the valve 82 is closed and liquid remains in the pitcher 22. A dispenser nozzle 84 may extend below the pitcher 22 which is engaged by a user. The dispenser nozzle 84 may be a conical structure having a narrow tip 86 to engage the check valve 82 and a bezel 88 having a circular shape to be engaged by a glass, water bottle, or other container 100 (shown in FIG. 1). As a user lifts a glass or other container 100 up into the bezel 88, the tip 86 of the dispenser nozzle 84 is pushed upward into the check valve 82 which unseats the valve 82 and allows liquid to flow from the pitcher 22 passed the valve 82 and into the container 100 below the bezel 88. As a user provides more upward force to the bezel 88, the check valve 82 reactively opens further, providing a larger flow rate of liquid out of the pitcher 22 and into the user's container 100. The round shape of the bezel 88 covers an opening of the container 100 to minimize splash from the liquid flowing out of the pitcher 22 into the container 100.

As also shown in FIG. 4, a beverage brewer 102 is provided and attached to the lid 30 and suspended from the underside of the lid 30 into the interior volume of the pitcher body 32. The brewer may be a secondary filtration beyond that of the refrigerator inline filter 54 that it tailored to remove specific compounds based on user need or desire such as specific toxins known to a region or per users health requirements such as for higher level of chlorine or other specific mineral removal such as sulfur compounds. In other instances, the brewer is provided to flavor or brew a beverage using the water provided from the water dispenser 16. The brewer 102 employs gravity to produce a flow rate of the water through the system.

As illustrated in FIGS. 3 and 4, the brewer includes a strainer 104, a diffuser 106, and a cap 108. The diffuser 106 is a cylindrical tube having an open end 110, which is attachable to the pitcher lid 30. The lid 30 may include an internally or externally threaded bung 112 that allows a user to attach the diffuser 106 to the bung 112. In some examples, the diffuser tube 106 may be molded plastic with slots 114 for allowing water to flow out of the tube. In other examples, the diffuser tube 106 may be formed of a perforated screen rolled into a cylinder and capped with plastic ends to hold the screen in place. In some instances, a check valve 111 is provided in the diffuser 106. For example, the check valve 111 may be a backflow check valve such as a butterfly or flapper-type valve provided in the inlet to the diffuser 106. The check valve 111 may be provided to prevent water from flowing back out the diffuser 106 when a user tilts the pitcher 22 to pour our the beverage in the pitcher 22.

The strainer 104 may be formed of a fine screen and configured to surround the diffuser tube 106. In other examples, the strainer 104 may be stainless steel wire, coated wire, or a perforated stainless steel sheet rolled to form a cup or bag shape. The diffuser 106 may be attached to the strainer 104, for example via weld, adhesive, cramp, or the like, to secure the diffuser 106 co-axially within the strainer 104 forming a volume 116 between the two components to be filled with filter media (not shown). The cap 108 may be a solid metal or molded plastic material. The strainer cap 108 may have an internally threaded through hole 118 for attachment to the diffuser tube 106. The cap 108 is configured to seal off the mesh strainer 104 to hold the filter media in the brewer 102. In some examples, the strainer cap 108 may be an elastomeric material that may stretch over the open end 110 of the diffuser tube 106 to engage the mesh strainer 104 with a force fit or in other examples with a threaded connection.

When the pitcher lid 30 is removed from the brewer 102, a user may load flavorants or loose filter media into the co-axial volume 116 between the diffuser tube 106 and the mesh strainer 104. For example, coffee grounds may be provided for making a cold brew coffee in the pitcher 22. In other examples, tea leaves or fruit or like particulate may be provided. The strainer cap 108 is then attached to the to diffuser tube 106 to hold the loaded brewer 102 together prior to being re-affixed to the pitcher lid 30 and placed in the pitcher body 32.

As the pitcher body 32 is inserted into the docking base 24, the proximity sensors and/or magnets 38 determine the pitcher 22 is positioned in proximity and in the correct orientation to receive water from the dispenser 16. The fluid level sensors and/or magnets 40 may be used to determine a fill level condition of the pitcher body 32. The fluid level condition may be determined or measured with floats, weight detection, or capacitance based on a liquid detection sensor. When the pitcher 22 has a fill level less than a full condition, the control switch 66 is configured to engage the dispenser 16 dispense water through the fill port 36 of the pitcher lid 30 and into the pitcher 22. The lid 30 acts as an initial fill portion having a hollow cavity with the fill port 36 on the top side and an outlet on the bottom side, and arranged to allow water into the pitcher body, primarily at the diffuser tube 106. Water is first collected in the diffuser tube 106 where it passes through the slots or perforations 114 in the diffuser 106 into the co-axial volume 116 between the diffuser 106 and the strainer 104 where the filter media is provided. The water flow may be slowed as it travels from the diffuser tube 106 radially outward through the filter media and then through the strainer 104 into the pitcher body 32. As the liquid level in the pitcher 22 rises, significant surface area of the filter media may be exposed for additional diffusion into the liquid. Once a full condition is met, the controller disengages the dispenser 16 to stop further addition of water into the pitcher body 32. Liquid may be kept in the pitcher body 32 throughout a desired diffusing time to create the desired effect on the water.

In some examples, the full condition may be met when the actual liquid level of a pitcher 22 is met. In other examples, the full condition may be met when the liquid level in the pitcher fill port 36 and/or diffuser tube 106 are met. A full condition based on the liquid level in the fill port 36 and/or diffuser tube 106 may be provided to create a regulated or slow flow into the pitcher 22 to allow for diffusing time where flow restriction from the diffuser tube 106 into the strainer 104 and pitcher body 32 is reduced due to the filter media. For example, the upstream flow may reach a “full” condition when the filter media or diffuser 106 causes flow restriction prior to the pitcher 32 actually reaching a full condition. In instances, a signal to the controller 66 may provide an interval of disengagement of the water dispenser 16 while the upstream flow settles and is dispersed through to the pitcher body 32.

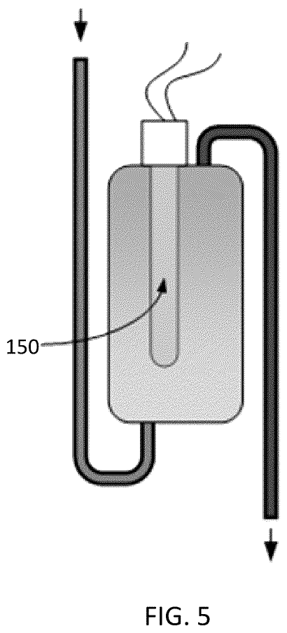

Referring to FIGS. 4 and 5, a heat source 140 may be provided to provide hot water to the brewer 102. Hot water may be helpful for producing various beverages such as coffee and tea. Where hot water contacts filter media like coffee grounds or tea leaves, the result may be a richer taste profile. In brewing cold brew coffee, filter media such as coffee grounds may be initially wet with hot water, waiting a desired time, and then pouring cold water over the grounds for the remaining desired liquid amount. The refrigerator 10 may be provided with a controller 66 and heater 140 for providing an initial amount of hot water to the pitcher body 32 to wet the filter media prior to pausing and then reengaging to dispense water at a cool temperature. In examples, the heater 140 may be an inline heater coil approximate the water dispenser. In other examples as shown in FIG. 5, a bottom fed reservoir with a cartridge heater 150 may also be used.

Additional variations and features will be readily appreciated by those of skill in the art and can be practiced with the above described alternative implementations without departing from the scope of the disclosure. The refrigerator 10 may be provided with error or failure detection means and deterrence. In one example, a time limit may be imposed on the operation of the water dispenser 16 to prevent a single, continuing dispensing from occurring while the access door 14 is shut greater than the maximum storage capacity of the water pitcher 22. Other water detectors or sensors may be provided near and below the water dispenser 16 to prevent the continued operation of the water dispenser 16 in the presence of water being detected within the fresh food storage section 12. Accordingly, visual or audible alarms may be provided to alert a user upon an error or fault detection event. Switch sensitivity may be increased and delay in actuation may be implemented so as to not dispense water unless the button 18 is engaged continuously for a minimum amount of time i.e., 3 seconds. In further alternatives, multiple interfaces or switches may be provided to allow the water pitcher 22 to interface and actuate the water dispenser 16 and to allow a human user to interface and actuate the water dispenser 16 separately from water pitcher 22.

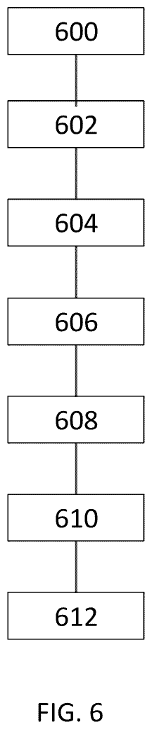

Referring now to FIG. 6, an exemplary flow chart illustrates a method for brewing a beverage in a refrigerator. At 600, a liquid storage receptacle has a lid with a fill port coupled with a diffuser and filter configured to hold a beverage brewing medium. A user may provide a medium such as coffee grounds into the filter. At 602, the liquid storage receptacle is docked in a docking base positioned in the refrigerator compartment. In a docked position, the liquid storage receptacle is positioned for the fill port in the lid to engage with a water dispenser of the refrigerator. At 604, a liquid level in the liquid storage receptacle is sensed, for example, via a fluid-level sensor. The presence and position of the liquid storage receptacle is also sensed, for example, via a proximity sensor. At 606, when the proximity sensor senses the water dispenser is docked appropriately in the docking base and the fluid-liquid sensor senses the liquid level is below a low-level threshold, the water dispenser dispenses water into the fill port of the lid to saturate the beverage brewing medium. The water dispenses at a first flow rate for an initial time period to saturate the medium. In some examples, the water that dispenses at a first flow rate may be heated to a desired or selected temperature. A user may set a desired water temperature and a desired initial saturation time via a controller based on the desired beverage and flavor profiles. At 608, after an initial time period, the water dispenser is disengaged to stop the flow of water into the liquid storage receptacle and allow the beverage brewing medium to set to a desired flavor profile. A user may set a preferred time for allowing the beverage medium to set via a controller. At 610, after the desired saturation time, the water dispenser may be reengaged to dispense water at a second flow rate. The second flow rate may be at a higher rate than the first flow rate. The water may also be dispensed at a cooler temperature. At 612, when the liquid-level meets or exceeds a high-level threshold in the liquid storage receptacle, the water dispenser is disengaged to stop water from flowing into the fill port. The beverage may continue to brew and the flavor may continue to steep as the beverage and brewing medium remain in the storage receptacle.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A liquid brewing and storage system for a refrigerator, the refrigerator having a water dispenser for selectively dispensing water, the system comprising:
a pitcher having a pitcher body and a removable lid engaged with the pitcher body;
a docking base for supporting the pitcher in the refrigerator; and
a beverage brewer comprising:
a diffuser for engaging the lid; and
a strainer for holding a filter medium in the beverage brewer;
wherein, when the pitcher is positioned in the docking base, the water is dispensed into the diffuser via the lid, and flows through the diffuser and strainer into the pitcher body, the filter medium diffusing the water into a desired beverage.

2. The system of claim 1, wherein when the pitcher is positioned in the docking base, the water is dispensed into the diffuser at a first flow rate for an initial time period, and wherein after the initial time period, the water is dispensed into the diffuser at a second flow rate that is higher than the first flow rate.

3. The system of claim 1, further comprising a heating device configured to selectively heat the water prior to dispensing into the diffuser.

4. The system of claim 1, wherein the pitcher or the docking base includes a proximity sensor configured to sense the presence of the pitcher in the docking base.

5. The system of claim 1, wherein the pitcher or the docking base includes a fluid-level sensor configured to sense the liquid level condition in the pitcher.

6. The system of claim 5, wherein when the liquid level condition is a full condition, the water dispenser stops providing water to the pitcher.

7. The system of claim 6, wherein the full condition is met when the pitcher is full of fluid or the diffuser is full of fluid.

8. The system of claim 1, wherein the removable lid of the pitcher forms a hollow cavity extending into the diffuser.

9. The system of claim 1, wherein the diffuser includes a plurality of slots for allowing the flow of water radially out of the diffuser into the filter medium held by the strainer.

10. The system of claim 9, wherein the strainer is formed of a mesh material allowing the flow of water out of the strainer.

11. The system of claim 10, wherein the mesh material is configured to hold the filter medium in the strainer, and wherein the filter medium is at least one of coffee grounds or tea leaves.

12. The system of claim 1, wherein the diffuser is at least partially surrounded by the strainer and the fluid medium is provided in a volume between the diffuser and the strainer.

13. A refrigerator with a liquid storage receptacle for brewing a beverage, the refrigerator comprising:
a water dispenser configured to selectively dispense water;
a docking base for supporting a liquid storage receptacle in a position to engage the water dispenser; and
a beverage brewer connected to the liquid storage receptacle, the beverage brewer comprising a diffuser and strainer for providing a filter medium to the water dispensed from the water dispenser.

14. The refrigerator of claim 13, further comprising a fluid-level sensor configured to sense the liquid level in the liquid storage receptacle, and a presence sensor configured to sense the presence of the liquid storage receptacle in the docking base.

15. The refrigerator of claim 14, further comprising a controller electrically connected to the water dispenser, the fluid-level sensor, and the presence sensor, wherein when the pitcher is sensed in the docking base and the liquid level is less than a low-level threshold, the water dispenser is operated by the controller to dispense water into the diffuser.

16. The refrigerator of claim 15, wherein the controller is configured to dispense water at a first flow rate for an initial time period, and wherein after the initial time period, the controller is configured to dispense water into the diffuser at a second flow rate that is higher than the first flow rate.

17. The refrigerator of claim 15, further comprising a heating device configured to selectively heat the water prior to dispensing into the diffuser.

18. The refrigerator of claim 13, wherein the diffuser is positioned inside the strainer, wherein filter medium is held between the diffuser and the strainer, wherein the water dispensed into the pitcher flows from the diffuser outward through the filter medium to the strainer and from the strainer into the liquid storage receptacle, and wherein the filter medium includes at least one of coffee grounds or tea leaves.

19. A method for brewing a beverage in a refrigerator, the method comprising:
providing a liquid storage receptacle having a lid with a fill port fluidly coupled with a filter configured to hold a beverage brewing medium;
docking the liquid storage receptacle in a docking base positioned in a refrigerator compartment with the fill port engaged with a water dispenser; and
sensing a liquid level in the liquid storage receptacle and a presence of the liquid storage receptacle in the docking base;
wherein when the liquid storage receptacle is sensed in the docking base and the liquid level is less than a low-level threshold, the water dispenser dispenses water into the fill port to saturate the beverage brewing medium and fill the liquid storage receptacle; and
wherein the liquid level meets or exceeds a high-level threshold, the water dispenser stops water from flowing into the fill port.

20. The method of claim 19, wherein the water is dispensed at a first flow rate for an initial time period to saturate the beverage brewing medium, wherein during the initial time period the water flow is stopped and the beverage brewing medium sets to a desired flavor profile, and wherein after the initial time period, the water is dispensed at a second flow rate that is higher than the first flow rate until the fluid meets or exceeds a high-level threshold.
